(19) United States
(12) Patent Application Publication
(10) Pub. No.: US 2010/0057470 A1
(43) Pub. Date: Mar. 4, 2010

(54) SYSTEM AND METHOD FOR VOICE-ENABLED MEDIA CONTENT SELECTION ON MOBILE DEVICES

(75) Inventors: Marja Marketta Silvera, Orinda, CA (US); Leo Chiu, South San Francisco, CA (US)

Correspondence Address: STEVENS LAW GROUP, 1754 TECHNOLOGY DRIVE, SUITE 226, SAN JOSE, CA, 95110, US

(73) Assignee: Apptera, Inc., San Bruno, CA (US)

(21) Appl. No.: 12/492,972

(22) Filed: Jun. 26, 2009

Related U.S. Application Data
(63) Continuation of application No. 11/132,805, filed on May 18, 2005, now abandoned.
(60) Provisional application No. 60/660,985, filed on Mar. 11, 2005.
(60) Provisional application No. 60/665,326, filed on Mar. 25, 2005.

(51) Int. Cl. G10L 21/00

(52) U.S. Cl. 704/275; 704/E21.001

(57) ABSTRACT

A system for voice-enabled location and execution for playback of media content selections stored on a media content playback device has a voice input circuitry for inputting voice-based commands into the playback device; codec circuitry for converting voice input from analog content to digital content for speech recognition and for converting voice-located media content to analog content for playback; and a media content synchronization device for maintaining at least one grammar list of names representing media content selections in a current state according to what is currently stored and available for playback on the playback device.

### CROSS-REFERENCE TO RELATED APPLICATIONS

The present application is a Continuation of co-pending U.S. patent application Ser. No. 11/132,805, filed on May 18, 2005, the disclosure of which is incorporated by reference herein. That application claims priority to provisional application Ser. No. 60/660,985, filed on Mar. 11, 2005 and provisional application Ser. No. 60/665,326 filed on Mar. 25, 2005. Both of those referenced applications are incorporated by reference herein in their entirety.

### BACKGROUND

The present invention is in the field of digital media content storage and retrieval from mobile, storage and playback devices and pertains particularly to a voice recognition command system and method for voice-enabled selection of media content stored for playback on a mobile device.

The art of digital music and video consumption has, more recently migrated from digital storage of media content typically on mainstream computing devices such as desktop computer systems to storage of content on lighter mobile devices including digital music players like the Rio™MP3 player, Apple Computer's iPod™, and others. Likewise, devices like the smart phone (third generation cellular phone), personal digital assistants (PDAs), and the like are also capable of storing and playing back digital music and video using playback software adapted for the purpose. Storage capability for these lighter mobile devices has been increased dramatically up to more than one gigabyte of storage space. Such storage capacity enables a user to download and store hundreds or even thousands of media selections on a single playback device.

Currently, the methods used to locate and to play media selections on those mobile devices is to manually locate and play the desired selection or selections through manipulation of some physical indicia such as a media selection button or, perhaps a scrolling wheel. In a case where hundreds or thousands of stored selections are available for playback, navigating to them physically may be, at best, time consuming and frustrating for an average user. Organization techniques such as file system-based storage and labeling may work to lessen manual processing related to content selection, however with many possible choices manual navigation may still be time consuming.

Therefore, what is needed in the art is a voice-enabled media content navigation system that may be used on a mobile playback device to quickly identify and execute playback of a media selection stored on the device.

### SUMMARY

According to an embodiment of the present invention, a system for voice-enabled location and execution for playback of media content selections stored on a media content playback device is provided. The system includes a voice input circuitry for inputting voice-based commands into the playback device; codec circuitry for converting voice input from analog content to digital content for speech recognition and for converting voice-located media content to analog content for playback; and a media content synchronization device for maintaining at least one grammar list of names representing media content selections in a current state according to what is currently stored and available for playback on the playback device.

In one embodiment, the playback device is a digital media player. In another embodiment, the playback device is a cellular telephone enhanced for multimedia dissemination and playback. In still another embodiment, the playback device is a personal digital assistant.

In a preferred embodiment, the voice-based commands are names of media content selections, the commands recognized by a speech recognition module enabled to recognize the commands spoken with the aid of the at least one grammar list. In one embodiment, the system further includes a media content library containing an updated master list of content selections available for playback on the device. In this embodiment, the media content synchronizer periodically synchronizes the names of content selections available for playback on the device with the names listed in the media content library, the synchronized list of names uploaded into the grammar base for use in speech recognition.

According to another aspect of the present invention, a system is provided for synchronizing media content of a media playback device with a remote media content server. The system includes a media playback device capable of communication with the server; and a media content synchronization module on the server, the module having read and write data access to the media storage system on the playback device over a data network. In one embodiment, the media playback device is a digital handheld playback device capable of receiving digital content while connected to the network. In another embodiment, the media playback device is a cellular telephone capable of receiving digital content while connected to the network. Also in one embodiment, the network is the Internet network.

In a preferred embodiment, the playback device includes a speech recognition module and a grammar base of names of media content selections available for playback on the device. In this embodiment, the content synchronization module updates the grammar base after a data session between the playback device and the content media server.

According to yet another aspect of the present invention, a method for synchronizing availability of media content selections for voice-enabled location and playback of the content from a media content playback device is provided and includes steps for (a) performing an action to change the actual or represented state of existence regarding one or more of the content selections available on the device; (b) establishing a data connection between the playback device and a remote server; (c) comparing the actual content selection names representing actual stored selections found on the device with a master list of names representing those selections; (d) creating a new list of content selection names, the list accurately representing those content selections stored on the device and those that will be stored on the device; and (e) downloading media content selection to the device from the server if required to resolve the list.

In one aspect in step (a), the action performed is one of an upload of one or more content selections to the playback device. In another aspect in step (a), the action performed is one of a deletion of one or more content selection from the device. In one preferred aspect in step (b), the data connection is established over the Internet. In preferred aspects, in step (b), the playback device is one of a cellular telephone, a personal digital assistant, or a digital music player and the connection is an Internet data connection.

In one aspect in step (c), names absent from the list representing names found on the device but included in the master list are sent to the device along with the appropriate content selections over the data connection. Also in this aspect in step (c), names absent from the master list, but included on the list representing names found on the device are added to the master list. In preferred aspects in step (d), the new list is a grammar list for download to the playback device, the grammar list supporting a speech recognition module for recognition of the listed names according to spoken voice input to the playback device by a user.

### BRIEF DESCRIPTION OF THE DRAWINGS

FIG. 1 is a block diagram illustrating a media playing device with a manual media content selection system according to prior art.

FIG. 2 is a bloc diagram illustrating voice-enabled media content selection system architecture according to an embodiment of the present invention.

FIG. 3 is a flow chart illustrating steps for synchronizing media with a voice-enabled media server according to an embodiment of the present invention.

FIG. 4 is a flow chart illustrating steps for accessing and playing synchronized media content according to an embodiment of the present invention.

### DETAILED DESCRIPTION

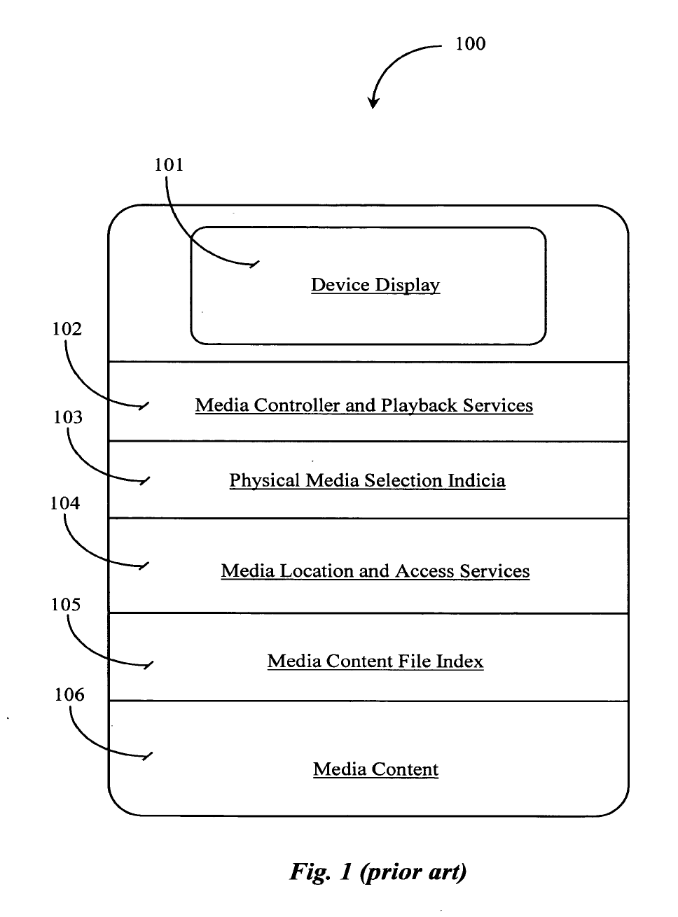

FIG. 1 is a block diagram illustrating a media playing device 100 with a manual media content selection system according to prior art. Media playing device 100 may be typical of many brands of digital media players on the market that are capable of playback of stored media content. Player 100 may be adapted to play either digital audio files and may, in some cases play audio/video files as well. Media player 100 may also represent some devices that are multitasking devices adapted to playback stored media content in addition to other tasks. A cellular telephone capable of download and playback of graphics, audio, and video is an example of such as device.

Device 100 typically has a device display 101 in the form of a light emitting diode (LED) screen or other suitable screen adapted to display content for a user operating the device. In this logical block illustration, the basic functions and services available on device 100 are illustrated herein as a plurality of sections or layers. These include a media controller and media playback services layer 102. The media controller typically controls playback characteristics of the media content and uses a software player for the purpose of executing and playing the digital content.

As described further above, device 100 has a physical media selection layer 103 provided thereto, the layer containing all of the designated indicia available for the purpose of locating, identifying and selection a media content for playback. For example, a screen scrolling and selection wheel may be used wherein the user scrolls (using the scroll wheel) through a list of media content stored.

Device 100 may have media location and access services 104 provided thereto that are adapted to locate any stored media and provide indication of the stored media on display device 101 for user manipulation. In one instance, stored media selections may be searched for on device 100 by inputting a text query comprising the file name of a desired entry.

Device 105 may have a media content indexing service 105 that is adapted to provide a content listing such as an index of media content selection stored on the device. Such a list may be scrollable and may be displayed on device display 101. Device 100 has a media content storage memory 106 provided thereto, which provides the resident memory space within which the actual media content is stored on the device. In typical art, an index like 105 is displayed on device display 101 at which time a user operating the device may physically navigate the list to select a media content file for execution and display. A problem with device 100 is that if many hundreds or even thousands of media files are stored therein, it may be extremely time consuming to navigate to a particular stored file. Likewise data searching using text may cause display of the wrong files.

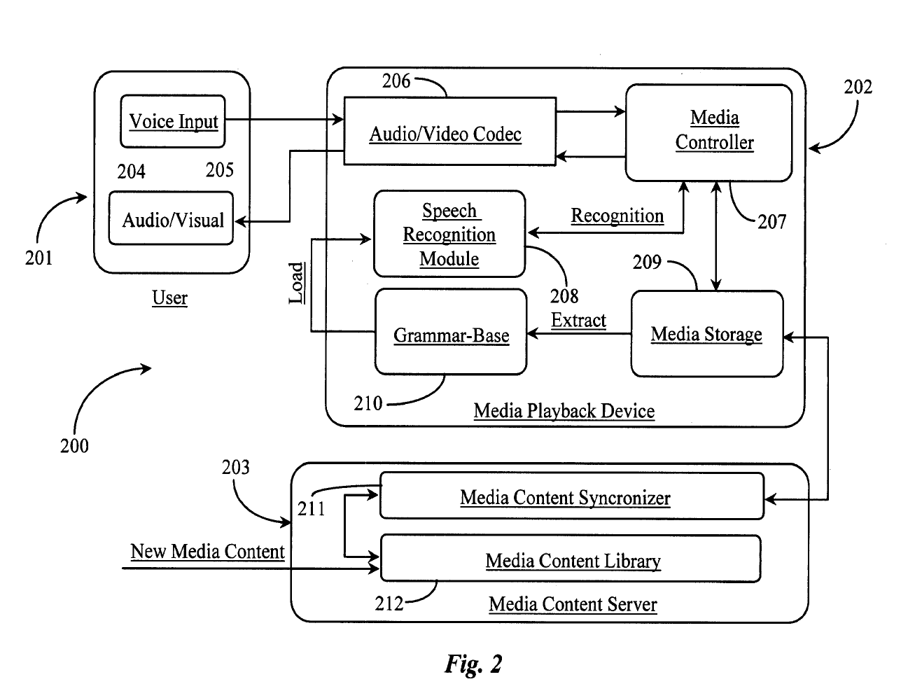

FIG. 2 is a bloc diagram illustrating voice-enabled media content selection system architecture 200 according to an embodiment of the present invention. Architecture 200 includes an entity or user 201, a media playback device 202, and a media content server 203, which may be external to or internal to playback device 202. User 201 is represented herein by two important interaction tasks performed by the user, namely voice input and audio/visual dissemination of content. User 201 may initiate voice input through a device like a microphone or other audio input device. User 201 listens to music and views visual content typically by observing a playback screen (not illustrated) generic to device 202.

Device 202 may be assumed to contain all of the component layers and functions described with respect to device 100 described above without departing from the spirit and scope of the present invention. According to a preferred embodiment of the present invention, device 202 is enhanced for voice recognition, media content location, and command execution based on recognized voice input.

Playback device 202 includes a speech recognition module 208 that is integrated for operation with a media controller 207 adapted to access and to control playback of media content. An audio/video codec 206 is provided within media playback device 202 and is adapted to decode media content and to convert digital content to analog content for playback over an audio speaker or speaker system, and to enable display of graphics on a suitable display screen mentioned above. In a preferred embodiment, codec 206 is further adapted to receive analog voice input and to convert the analog voice input into digital data for use by media controller to access a media content selection identified by the voice input with the aid of speech recognition module 208.

Media playback device 202 includes a media storage memory 209, which may be a robust memory space of more than one gigabyte of memory. A second memory space is reserved for a grammar base 210. Grammar base 210 contains all of the names of the executable media content files that reside in media storage 209. All of the names in the grammar base are loaded into, or at least accessed by the speech recognition module 208 during any instance of voice input initiated by a user with the playback device powered on and set to find media content. There may be other voice-enabled tasks attributed to the system other than specific media content selection and execution without departing from the spirit and scope of the present invention.

Media content server 203 has direct access to media storage space 209. Server 203 maintains a media library that contains the names of all of the currently available selections stored in space 209 and available for playback. A media content synchronizer 211 is provided within server 203 and is adapted to insure that all of the names available in the library represent actual media that is stored in space 209 and available for playback. For example, if a user deletes a media selection and it is therefore no longer available for playback, synchronizer 211 updates media content library 212 of the deletion and the name is purged from the library.

Grammar base 210 is updated, in this case, by virtue of the fact that the deleted file no longer exists. Any change such as deletion of one or more files from or addition of one or more files to device 202 results in an update to grammar base 210 wherein a new grammar list is uploaded. Grammar base 210 may extract the changes from media storage 209, or content synchronizer may actually update grammar base 210 to implement a change. When the user downloads one or more new media files, the names of those selections are updated into media content library 212 and synchronized ultimately with grammar base 210. Therefore, grammar base 210 always has a latest updated list of file names on hand for upload into speech recognition module 208.

As described further above, media server 203 may be an onboard system to media device 202. Likewise, sever 203 may be an external, but connectable system to media playback device 202. In this way, many existing media playback devices may be enhanced to practice the present invention. Once media content synchronization has been accomplished, speech recognition module 208 may recognize any file names uttered by a user.

According to a further enhancement, user 201 may conduct a voice-enabled media search operation whereby generic terms are, by default, included in the vocabulary of the speech recognition module. For example, the terms jazz, rock, blues, hip-hop, and Latin, may be included as search terms recognizable by module 208 such that when detected, cause only file names under the particular genre to be selectable. This may prove useful for streamlining in the event that a user has forgotten the name of a selection that he or she wishes to execute by voice. A voice response module may, in one embodiment, be provided that will audibly report the file names under any particular section or portion of content searched back to the user. Likewise other streamlining mechanisms may be implemented within device 202 without departing from the spirit and scope of the invention such as enabling the system to match an utterance with more than one possibility through syllable matching, vowel matching, or other semantic similarities that may exist between names of media selections. Such implements may be governed by programmable rules accessible on the device and manipulated by the user.

One with skill in the art will recognize that in an embodiment of a remote media server from the playback device, that the synchronization between the playback device media player and the media content server can be conducted through a docking wired connection or any wireless connection such as 2 G, 2.5 G, 3 G, 4 G, WIFI, WIMAX, etc. Likewise, appropriate memory caching may be implemented to media controller 207 and/or audio/video codec 206 to boost media playing performance.

One of skill in the art will also recognize that media playback device 202 might be of any form and is not limited to a standalone media player. It can be embedded as software or firmware into a larger system such as a PDA phone or smart phone or any other system or sub-system.

In one embodiment, media controller 202 is enhanced to handle more complex logics to enable the user 201 to perform more sophisticated media content selection flow such as navigating via voice a hierarchical menu structure attributed to files controlled by media playback device 202. As described further above, certain generic grammar may be implemented to aid navigation experience such as “next song”, “previous song”, the name of an album or channel or the name of the media content list, in addition to the actual media content name.

In still a further enhancement, additional intelligent modules such as the heuristic behavioral architecture and advertiser network modules can be added to the system to enrich the interaction between the user and the media playback device. The inventor knows of intelligent systems for example that can infer what the user really desires based on navigation behavior. If a user says rock and a name of a song, but the song named and currently stored on the playback device is a remix performed as a rap tune, the system may prompt the user to go online and get the rock and roll version of the title. Such functionality can be brokered using a third-party subsystem that has the ability t connect through a wireless or wired network to the user's playback device. Additionally, intelligent modules of the type described immediately above may be implemented on board the device as chip-set burns or as software implementations depending on device architecture. There are many possibilities.

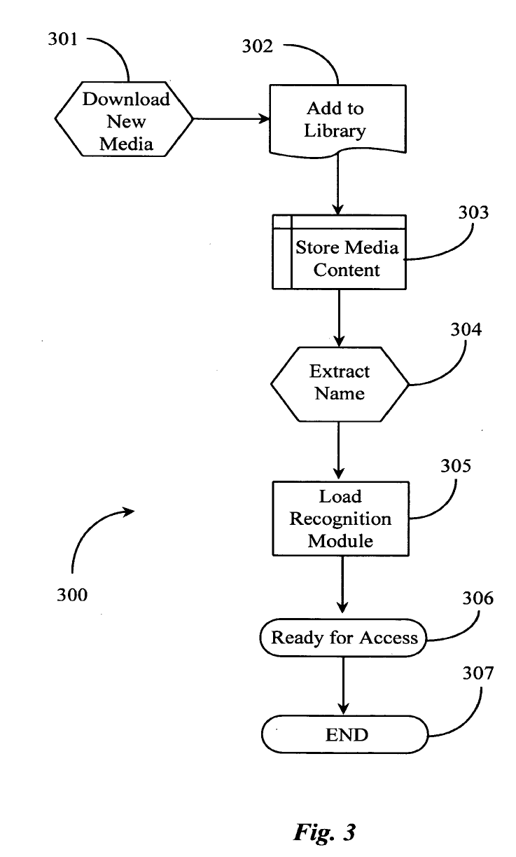

FIG. 3 is a flow chart 300 illustrating steps for synchronizing media with a voice-enabled media server according to an embodiment of the present invention. At step 301, the user authorizes download of a new media content file or file set to the device. At step 302, the media content synchronizer adds the name of the content to the media content library. The name added might be constructed by the user in some embodiments whereby the user types in the name using an input device and method such as may be available on a smart telephone. The synchronizer makes sure that the content is stored and available for playback at step 303. At step 304, the name for locating and executing the content is extracted, in one embodiment from the storage space and then loaded into the speech recognition module by virtue of its addition to the grammar base leveraged by the module. In one embodiment, in step 304, the synchronization module connects directly from the media content library to the grammar base and updates the grammar base with the name.

At step 306, the new media selection is ready for voice-enabled access whereupon the user may utter the name to locate and execute the selection for playback. At step 307, the process ends. The process is repeated for each new media selection added to the system. Likewise, the synchronization process works each time a selection is deleted from storage 209. For example, if a user deletes media content from storage, then the synchronization module deletes the entry from the content library and from the grammar base. Therefore, the next time that the speech recognition module is loaded with names, the deleted name no longer exists and therefore the selection is no longer recognized. If a user forgets a deletion of content and attempts to invoke a selection, which is no longer recognized, an error response might be generated that informs the user that the file may have been deleted.

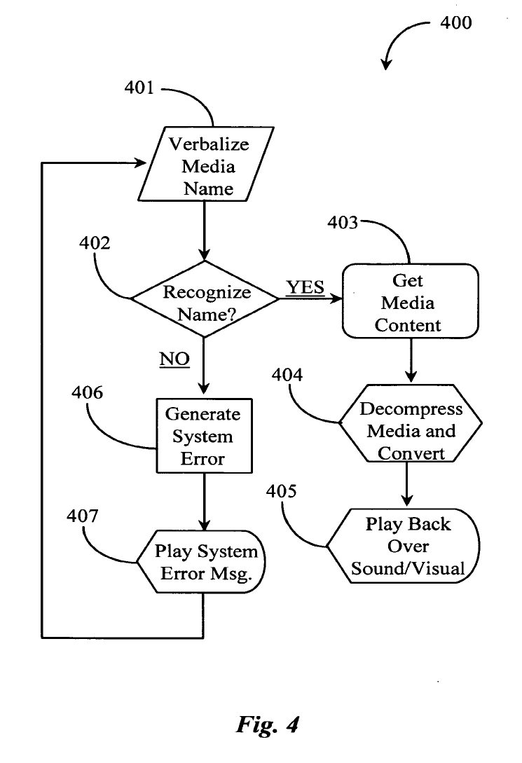

FIG. 4 is a flow chart 400 illustrating steps for accessing and playing synchronized media content according to an embodiment of the present invention. At step 401, the user verbalizes the name of the media selection that he or she wishes to playback. At step 402, the speech recognition module attempts to recognize the spoken name. If recognition is successful at step 402, then at step 403, the system retrieves the media content and executes the content for playback.

At step 404 the content is decompressed and converted from digital to analog content that may be played over the speaker system of the device in step 405. If at step 402, the speech recognition module cannot recognize the spoken file name, then the system generates a system error message, which may be in some embodiments, an audio response informing the user of the problem at step 407. The message may be a generic recording played when an error occurs like “Your selection is not recognized” “Please repeat selection now, or verify its existence”.

The methods and apparatus of the present invention may be adapted to an existing media playback device that has the capabilities of playing back media content, publishing stored content, and accepting voice input that can be programmed to a playback function. More sophisticated devices like smart cellular telephones and some personal digital assistants already have voice input capabilities that may be re-flashed or re-programmed to practice the present invention while connected, for example to an external media server. The external server may be a network-based service that may be connected to periodically for synchronization and download or simply for name synchronization with a device. New devices may be manufactured with the media server and synchronization components installed therein.

The methods and apparatus of the present invention may be implemented with all of some of or combinations of the described components without departing from the spirit and scope of the present invention. In one embodiment, a service may be provided whereby a virtual download engine implemented as part of a network-based synchronization service can be leveraged to virtually conduct, via connected computer, a media download and purchase order of one or more media selections.

The specified media content may be automatically added to the content library of the user's playback device the next time he or she uses the device to connect to the network. Once connected the appropriate files might be automatically downloaded to the device and associated with the file names to enable voice-enabled recognition and execution of the downloaded files for playback. Likewise, any content deletions or additions performed separately by the user using the device can be uploaded automatically from the device to the network-based service. In this way the speech system only recognizes selections stored on and playable from the device.

What is claimed is:

1. A system for voice-enabled location and execution for playback of media content selections stored on a media content playback device comprising:
a voice input circuitry for inputting voice-based commands into the playback device;
codec circuitry for converting voice input from analog content to digital content for speech recognition and for converting voice-located media content to analog content for playback; and
a media content synchronization device for maintaining at least one grammar list of names representing media content selections in a current state according to what is currently stored and available for playback on the playback device.
